(19) United States
(12) Patent Application Publication
(10) Pub. No.: US 2024/0015878 A1
(43) Pub. Date: Jan. 11, 2024

(54) DEVICE FOR ELECTRICAL DISCHARGE PROCESSING OF NON-CONDUCTING LIQUIDS

(71) Applicant: AGC GLASS EUROPE, Louvain-la-Neuve (BE)

(72) Inventors: Philippe ROQUINY, Moustier-sur-Sambre (BE); Philippe BELLET, Sars-la-Buissiere (BE); Sébastien ADANS, Namur (BE)

(73) Assignee: AGC GLASS EUROPE, Louvain-la-Neuve (BE)

(21) Appl. No.: 18/253,080

(22) PCT Filed: Nov. 25, 2021
(86) PCT No.: PCT/EP2021/083072

§ 371 Date: May 16, 2023

(30) Foreign Application Priority Data
Nov. 24, 2020 (EP) 20209418.1

(51) Int. Cl. H05H 1/24

(52) U.S. Cl. CPC H05H 1/2437; H05H 2242/22; H05H 2245/20

(57) ABSTRACT

A device for the electrical discharge processing of a non-conducting liquid including at least one alternating succession of essentially rectangular, parallel, and spaced-apart n electrode plates and n+1 dielectric plates, with n≥2, the electrode plates being numbered from 1 to n; the device includes a series of first electrical connectors electrically connected to all even numbered electrode plates in proximity to a first pair of diametrically opposite corners; and the device includes a series of second electrical connectors electrically connected to all odd numbered electrode plates in proximity to a second pair of diametrically opposite corners. Further, a method for electrical discharge processing of a non-conducting liquid using the device is disclosed.

### TECHNICAL FIELD

The present invention relates to a device for electrical discharge processing of non-conducting liquids. These non-conducting liquids may for example be hydrocarbons, silicon-containing compounds, and fatty substances of animal origin or of plant origin.

By “liquid” me mean compounds that remain liquid under the conditions of the present electrical discharge processing. By “non-conducting liquid”, we mean a liquid of relatively high electrical resistivity, in particular having a resistivity which is at least 1×10⁸ ohm cm, at 25° C. and preferably up to 125° C. The non-conducting liquid may for instance be a hydrocarbon oil or a paraffin. In particular, by “liquid, silicon-containing compound”, we mean those chemical entities comprising at least one silicon atom. The term “fatty substance” according to the present invention refers to substances composed of molecules having hydrophobic properties and being mainly composed of triglycerides. Triglycerides are esters formed of a glycerol molecule and three fatty acids. These fatty substances comprise oils, waxes and fats. In the scope of the present invention, the oils are preferred as they are in a liquid state at room temperature since they are mainly composed of unsaturated fatty acids and thus have low melting points, that is less than or equal to room temperature. The fats and waxes are, on the other hand, pasty or solid at room temperature as they have a melting point which is higher than room temperature, as they are mainly formed of saturated fatty acids. The melting point being higher for fats and waxes, their use in the device according to the present invention must preferably be carried out at a temperature which is higher than room temperature, so they are in liquid form.

Electrical discharge processing by electrical discharge of a non-conductive liquid, such as an oil of plant or mineral origin in liquid form, also known as voltolisation, is a method involving electrical discharges so-called silencers. The electrical discharges are produced between two metal electrodes or a series of parallel metal electrodes which are separated by an electrical insulator, also known as dielectric material. The application of an alternating electrical voltage between the electrodes allows a plasma to be created between them, through the dielectric material. This plasma enables the processing of the oil in the form of film on the surface of the electrodes and the dielectric.

### BACKGROUND ART

It is known from the prior art, particularly in document FR363078, to rely on an electrical discharge processing device to eliminate the characteristic unpleasant smell of fish oil. In this document, the fish oil is contained in a cylindrical enclosure and is in contact with hydrogen. The hydrogen then binds itself to the fish oil following electrical discharges applied between the electrodes in the enclosure, thus allowing the unpleasant smell of fish oil to be gradually removed.

The hydrogen consumed during that reaction is quickly and manually reintroduced into the enclosure thanks to a tap provided for this purpose. The operating conditions for this processing of fish oil are not described in the document.

Evidence was then given in the prior art that an electric processing of liquid organic material enabled the physicochemical properties thereof to be modified. This method was therefore also applied in the past to “thicken” vegetable or mineral oils or a mixture thereof, in order to procure properties suitable for use as additives in lubricants.

A device known for electrical discharge processing of liquid organic material comprises a series of electrodes comprising a number n of substantially parallel electrodes (1 and 2), where n≥2, each electrode being arranged to be connected to a high-voltage source and/or to ground, a series of dielectric material elements comprising n+1 dielectric material elements substantially parallel to said electrodes and placed on either side of each electrode of the series of electrodes, so that each electrode is between two dielectric material elements, an enclosure arranged to receive said non-conductive liquid and encircling said series of electrodes and said series of dielectric material elements and an immersion device of said series of electrodes and said series of dielectric material elements arranged to at least partially submerge said series of electrodes and said series of dielectric materials.

Document GB 407379 A describes a device for processing hydrocarbon oils and paraffin by means of electrical discharges. The device for electrical discharge processing (voltolisation) illustrated in this document is a condenser, in the form of a tube, containing a plurality of metal plates placed in series, separated from one another by glass plates. The metal plates are alternately connected to a high-frequency current source, which means that when a first metal plate is connected to a high-frequency current source, the second opposing metal plate serves as the ground electrode. A glass plate is then situated between a metal plate connected to a current source and a metal plate serving as the ground electrode. The glass plates may be rotated around a central axis of the condenser. The metal plates and the glass plates are submerged in the hydrocarbon to be processed.

A similar device for applying electrical discharges to a liquid is described in document GB 190507101 A. The device described in this document is also composed of a cylindrical enclosure which can be rotated in which the gas pressure can be kept relatively constant thanks to a complementary device having a mercury manometer. In this way, when the gas pressure in the enclosure, measured by the mercury manometer, drops, gas can be reintroduced into the enclosure. Therefore, the gas pressure in the enclosure increases to return to its initial value so that the gas pressure in the enclosure is kept relatively constant. A series of metal discs and discs of insulating material are alternately placed on a rotating shaft of the enclosure, that is they are placed successively along the rotating shaft as follows: a metal disc, a disc of insulating material, a metal disc, a disc of insulating material, and so on. The insulating material, also known as dielectric material, placed between the electrodes allows the formation of local arcing to be reduced, which could cause a too-intensive local processing of the liquid, resulting in the deterioration of the processed liquid.

Unfortunately, the previous devices give very random results when they are used to process vegetable or mineral oils. The physicochemical properties of the processed oils are neither predictable nor controllable/controlled. In addition, the implementation of the devices disclosed is not described, which does not allow there to be any industrial development. It has been reported that industrial development of the devices disclosed was not possible as the operational conditions which were not disclosed were unique to these specific devices and gave random results.

Other prior art present connections to the power supply possibly alternate, but always only at one side of each plate also the electrodes in these documents are not adapted for processing non-conductive liquids as they are covered in insulators. Documents WO 9815357 A1, EP1809082 A1 and CN 106793435 A describe devices for plasma treating gases and aqueous solutions.

Document WO 2018002329 A1 describes a device for more controllable electrical discharge processing of fatty substances of plant origin wherein the electrodes are individually connected in such a way that the current flow distances between an electrical connector placed on the outer surface of the enclosure and any electrode is the same. This way of connecting the electrodes severely complicates upscaling of such devices as every electrode requires its own electrical connector. Furthermore it was found that on large electrodes, for example larger than 0.2 square meter, the plasma was not homogeneously distributed over the whole electrode.

### SUMMARY OF INVENTION

It is an objective of the present invention to provide a device which is capable of being easily scaled up and wherein the electrical discharge processing of a non-conducting liquid is controlled, reproducible, and uniform.

To solve this problem, the invention provides a device for the electrical discharge processing of a non-conducting liquid comprising at least one alternating succession of essentially rectangular, parallel, and spaced-apart n electrode plates and n+1 dielectric plates, with n≥2, the electrode plates being numbered from 1 to n; characterized in that the device comprises a series of first electrical connectors electrically connected to all even numbered electrode plates in proximity to a first pair of diametrically opposite corners; and in that the device comprises a series of second electrical connectors electrically connected to all odd numbered electrode plates in proximity to a second pair of diametrically opposite corners. The device further comprises an AC power source having a first pole connected to the series of first electrical connectors and a second pole connected to the series of second electrical connectors.

In order to improve the reproducibility, control and uniformity of the electrical discharge processing of a non-conducting liquid during the implementation of the device according to the present invention, the inventors have surprisingly noticed that, by supplying current to each electrode simultaneously at diametrically opposed corners, the plasma is established homogeneously over the electrode plates, any electrical arcs and non-homogeneous processing of the non-conducting liquid, e.g. vegetable oil, present in the form of film on the surface of this electrode and the dielectric plates are limited and even avoided. This result is achieved even though the length of the electric path between power source and electrode plate may vary from electrode plate to electrode plate.

Consequently, the processing of a non-conducting liquid in a device according to the present invention is faster and more effective while allowing the physicochemical properties of the treated non-conducive liquid resulting from the processing to be controlled. In fact, the application of a too-intensive processing to a non-conducting liquid, such as a vegetable oil for example, such as it happens when arcs occur, leads to the too-quick thickening of the oil and may cause the formation of insoluble agglomerate, and thus the formation of a sediment.

Another, additional, advantage of the device of the present invention is that it can be scaled up easily by avoiding the necessity to precisely control the path length of the current between the power source and the electrode plates.

The n electrode plates and n+1 dielectric plates are positioned in an alternating succession. This means that dielectric plates and electrode plates are placed in alternation with each other, so that any electrode plate is between two dielectric plates.

The n electrode plates and n+1 dielectric plates are spaced-apart. This means that they are not in direct contact with each other.

The device of the present invention is preferably configured for distributing said non-conducting liquid on the surfaces of said n electrode plates and, optionally n+1 dielectric plates and for forming a film of said non-conducting liquid on the surface of said electrodes and optionally said dielectric plates. The device may comprise above each electrode plate and optionally each dielectric plate a distributor for said non-conducting liquid.

According to an embodiment of the present invention the surface area of dielectric plates is larger than the surface area of the electrode plates. Advantageously, as illustrated in FIG. 4, the dielectric plate (3) extends further than the electrode plate (1) in both directions along both X and Z axes. The Inventors have found that by having the dielectric plates extending beyond the electrode plates, direct arcs between neighboring electrode plates may be more easily avoided.

Odd numbered and even numbered electrode plates are placed in alternation with each other. An odd numbered electrode thus faces an even numbered second electrode, and so on, so that two electrodes of the same type are not in sequence, with a dielectric plate in between each electrode plate.

In the following description, the expression “non-conducting liquids” will be, for reasons of simplicity, also occasionally expressed by the term of oil. The term “oil” is used for reasons of simplicity, as the non-conducting liquid used according to the present invention is in liquid form under the processing conditions, whether it comes from an animal or vegetable oil, fat, or wax or from a natural or synthetic hydrocarbon or from a silicon-containing compound. As explained above, when a fat or a wax is used, the operating temperature is preferably adapted so it is in liquid form.

Fatty substances of plant origin may come from, for example, rapeseed, flaxseed, argan, etc.

Preferably, the non-conducting liquid has a degree of unsaturation, in particular has a pre-processing iodine value ranging between 100 and 180.

According to the present invention, the term “high voltage” refers to a voltage, also known as a potential, preferably ranging between 1 kV and 10 kV, advantageously between 2 kV and 3 kV and characterized by a low alternating current of which the current density is preferably between 0.5 and 2 mA/cm² and of which the frequency is advantageously between 3 and 100 kHz, advantageously between 5 and 70 kHz, more advantageously between 10 and 40 kHz.

According to the present invention, the device comprises a series of electrode plates comprising at least n=2 electrode plates electrically connected via an AC power source, preferably in such a way that, when any odd numbered, electrode plate is supplied with a current, any even numbered electrode plate is supplied with the opposite current. Preferably, none of the electrode plates are grounded.

“AC power” is taken to mean electric power from an alternating source wherein the voltage is changing at some frequency in a manner that is sinusoidal, square wave, pulsed or some other waveform. Voltage variations are often from negative to positive. The average current per period averages to 0 A. When in bipolar form, power output delivered by two leads is generally about 180° out of phase. The AC power source supplies a varying or alternating bipolar voltage to the two electrodes. The AC power supply—or AC power source—initially drives the odd numbered electrode plates to a negative voltage, allowing plasma formation, while the even-numbered electrode plates are driven to a positive voltage in order to serve as an anode for the voltage application circuit. This then drives the first electrode to a positive voltage and reverses the roles of cathode and anode.

In a preferred embodiment the power source in the present invention combines a solid state power supply with a transformer. Thereby the economic and technical advantages of solid state power supplies, advanced levels of control, flexibility, and facility design are maintained and the relatively low voltages of common solid state power supplies, typically about 800 to 1000V are compensated by the combination with a transformer so as to reach the required kV range mentioned hereinabove.

### BRIEF DESCRIPTION OF DRAWINGS

These and further aspects of the invention will be explained in greater detail by way of example and with reference to the accompanying drawings in which:

FIG. 1 shows a schematic three dimensional view of an alternating sequence of parallel, rectangular, spaced apart, dielectric plates and electrode plates according to an embodiment of the present invention.

FIG. 2 shows a schematic three dimensional view of an example embodiment of the electrical connections between the electrode plates and the power source according to an embodiment of the present invention.

FIG. 3 shows a schematic view of the designations used for the four corners of the electrode plates.

FIG. 4 shows a front view of an electrode plate and a dielectric plate.

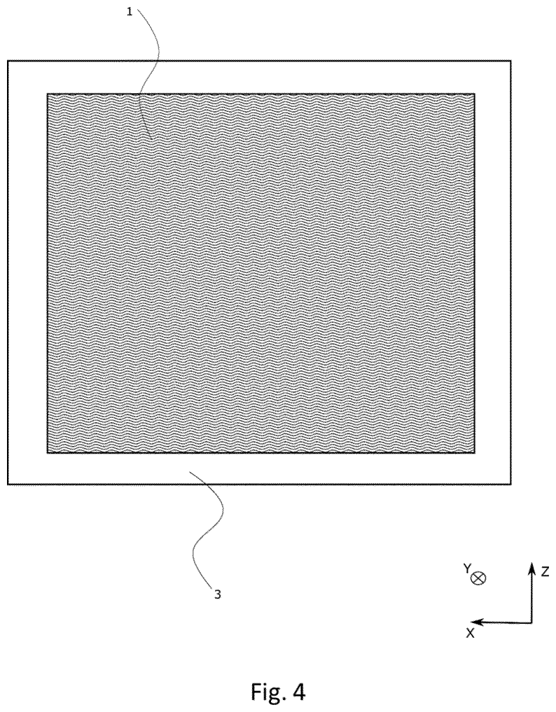

The Figures are not drawn to scale.

### DESCRIPTION OF EMBODIMENTS

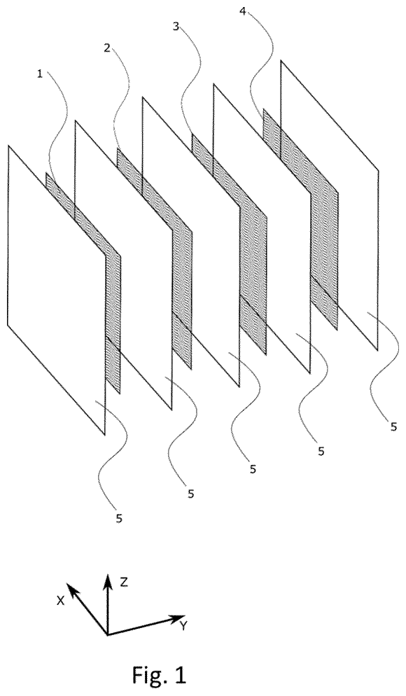

According to the present invention the electrode plates and dielectric plates are spaced apart and therefore all lie in separate planes parallel to the XZ plane as illustrated in FIG. 1. FIG. 1 illustrates an alternating sequence of parallel, rectangular, spaced apart, dielectric plates (5) and electrode plates (1, 2, 3, 4) according to an embodiment of the present invention. Electrode plates (1, 2, 3, 4) and dielectric plates (5) are arranged in distinct XZ planes and spaced apart along axis Y. Every electrode plate (1, 2, 3, 4) is situated in between two dielectric plates (5). The electrode plates are aligned with regard to each other and dielectric plates are aligned with regard to each other.

According to an advantageous embodiment of the present invention, the space between electrode plates and dielectric plates is advantageously comprised between 4 and 10 mm, more advantageously between 5 and 7 mm.

According to an advantageous embodiment of the present invention the number of electrode plates n is comprised between 2 and 100, more advantageously between 5 and 50, even more advantageously between 8 and 30 and preferably between 12 and 22.

According to an embodiment of the present invention the electrode plates and dielectric plates are held apart by one or more guide rails positioned at the bottom, at the top and/or at the sides of the plates. The guide rails may for example be provided with notches in which the electrode and dielectric plates may be easily located. The n electrode plates and n+1 dielectric plates of the present device may be held together in a rack, preferably comprising the aforementioned guide rails, that may serve to hold the plates in position.

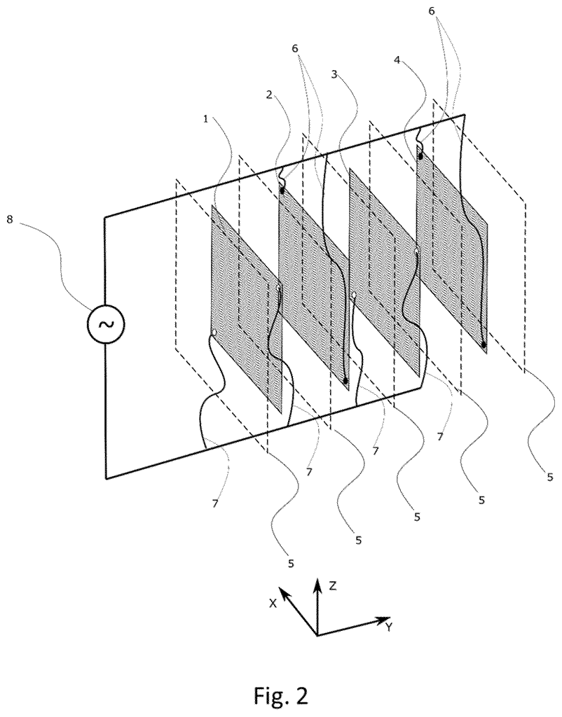

FIG. 2 illustrates the electrical connections of the electrode plates according to an embodiment of the present invention. A series of first electrical connectors (6) are electrically connected to all even numbered electrode plates (2, 4) at a pair of first diametrically opposite corners and a series of second electrical connectors (7) are electrically connected to all odd numbered electrode plates (1, 3) at a pair of second diametrically opposite corners. In this figure the dielectric plates' (5) contours only are indicated by dashed lines in order to better illustrate the electrical connectors. First and second electrical connectors (6, 7) are electrically connected to and AC power source (8).

In an embodiment, the device of the present invention further comprises an AC power source and at least n=2 electrode plates are connected to each other via said AC power source. The average current per period averages to 0 A. The AC power source supplies a varying or alternating bipolar voltage to the at least two electrodes. The bipolar power supply initially drives all odd numbered electrode plates to a negative voltage, allowing plasma formation, while the even numbered electrode plates are driven to a positive voltage in order to serve as an anode for the voltage application circuit. This then drives the odd numbered electrode plates to a positive voltage and reverses the roles of cathode and anode. A plasma is established in between odd numbered and even numbered electrode plates. forms within the corresponding cavity. The other cathode then forms an anode, causing electrons to escape the plasma and travel to the other side, thereby completing an electric circuit.

According to an embodiment of the present invention the AC power source may comprise a power supply that is stabilized in amplitude and in frequency and may further comprise a high voltage and high frequency transformer.

According to an embodiment of the present invention the AC power source may be configured to supply current at a frequency, comprised between 3 and 300 kHz and high voltage comprised between 1 and 5 kV.

It is also possible, though not preferred, to alternately connect even-numbered electrode plates to the high-voltage source and odd-numbered electrode plates to ground, or vice-versa, so as to have an alternating sequence of a dielectric plate, an electrode plate connected to the high-voltage source, a dielectric plate, an electrode plate connected to the high-voltage source and a dielectric material element, and so on.

According to an embodiment of the present invention, the device further comprises an enclosure wherein the alternating successions of electrode plates and dielectric plates are placed.

The enclosure according to the present invention is advantageously an essentially rectangular prism shaped, preferably made of metal more preferably made of stainless steel.

Advantageously, the enclosure further comprises a non-conducting liquid outlet, situated in a lower part of the enclosure and a non-conducting liquid inlet, situated in an upper part of the enclosure. According to an advantageous embodiment of the present invention the enclosure comprises more than one non-conducting liquid inlet.

According to an embodiment of the present invention, the enclosure comprises at least two separate electrical feedthrough connectors via which the odd and even-numbered electrode plates are respectively electrically connected to the power source. The electrical feedthrough connectors advantageously comprise electrical insulators, for electrically separating them from the enclosure. The electrical feedthrough connectors are advantageously at least 3 cm, at least 5 cm, at least 10 cm distant from each other. The two separate electrical feedthrough connectors are feed respectively opposing alternating current to the electrodes.

According to an embodiment of the present invention the enclosure is lined on the inside with an electrically insulating lining. Thereby arcing between electrode plates and the enclosure may be avoided.

According to an embodiment of the present invention the enclosure is able to operate at a pressure of 10 to 400 Torr, preferably of 80 to 300 Torr and more preferably of 100 to 260 Torr.

According to an embodiment of the present invention, the enclosure of the present invention advantageously further comprises a gas exhaust port that may be connected to a vacuum pump.

According to an embodiment of the present invention, the enclosure of the present invention may further comprise at least one gas inlet port for admitting one or more process gasses necessary for performing the process into the enclosure. The process gasses may advantageously be chosen among one or more of any noble gas, nitrogen, oxygen, and hydrogen. During the oil processing, the process gas, for example, hydrogen, may be consumed; the pressure in the enclosure may thus tend to decrease as a result of the oil processing time. A pressure gauge may allow the gas pressure in the enclosure to be measured and thereby control the injection of additional quantities of process gasses.

According to an embodiment of the present invention a pressure comprised between 10 to 400 Torr, preferably between 80 to 300 Torr and more preferably of 100 to 260 Torr may be maintained during processing of the non-conductive liquid. Lower pressures facilitate the forming of a plasma, in particular in the presence of non-conducting liquids on the electrodes.

In an advantageous embodiment of the device according to the present invention, said enclosure also has at least one inclined surface for guiding the non-conductive liquid to the first non-conductive liquid outlet of the vessel. This inclined surface for guiding allows the non-conductive liquid to be supplied to said non-conductive liquid outlet in the enclosure so as to further facilitate the circulation of said non-conductive liquid outside the enclosure.

In an advantageous embodiment of the device according to the present invention further comprises a pressure gauge placed in the enclosure and arranged to measure the gas pressure in the enclosure. The pressure gauge may be a capacitive vacuum gauge, for example of the MKS brand, which allows the gas pressure in the enclosure to be measured. During the oil processing, the first gas, for example, hydrogen, may be consumed; the pressure in the enclosure may thus tend to decrease as a result of the oil processing time. The pressure gauge allows the gas pressure in the enclosure to be measured and therefore to know when it is necessary to inject a quantity of the first supplementary gas to maintain a constant gas pressure in the enclosure.

Additionally, an embodiment of the present invention, the device further comprises a controller arranged to be connected to said pressure gauge and connected to a flowmeter, or a fast response leak valve, said controller being arranged to control the flowmeter, leak valve said flowmeter being arranged to be in fluid connection with said second inlet for a first gas of the enclosure to measure the quantity of said first gas injected into the enclosure by said second inlet for a first gas of the enclosure.

When the pressure gauge measures a gas pressure in the enclosure which is too low, a gas injection may be made via an inlet for gas of the enclosure and the quantity of gas injected is advantageously controlled thanks to the flowmeter.

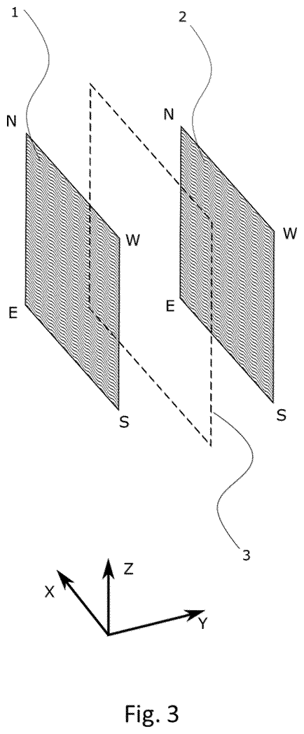

According to the present invention a series of first electrical connectors electrically connected to all even numbered electrode plates at a pair of first diametrically opposite corners and a series of second electrical connectors electrically connected to all odd numbered electrode plates at a pair of second diametrically opposite corners. FIG. 3 illustrates how the corners of electrode plates (1,2) may be designated. In this figure the dielectric plates' (5) contours only are indicated by dashed lines for clarity. In both odd-numbered electrode plate (1) and even-numbered electrode plate (2) the corners are labelled in a clockwise fashion, ‘N’, ‘W’, ‘S’, and ‘E’. The corners (N) and (S) form a pair of diametrically opposite corners and the corners (E) and (N) form a pair of diametrically opposite corners. The pair of corners (N,S) of odd-numbered electrode plate (1) and the pair of corners (E,W) of even-numbered electrode plate (2) are positioned transversely to each other.

According to an exemplary embodiment of the present invention the first electrical connectors are electrically connected to all odd numbered electrode plates at the same first pair of diametrically opposite corners (E,W) or (N,S), and the second electrical connectors are electrically connected to all even numbered electrode plates at the same second pair of diametrically opposite corners (E,W) or (N,S).

In a preferred embodiment of the present invention, the first pairs of diametrically opposite corners and the second pairs of diametrically opposite corners are positioned transversely to each other, for example on FIG. 2 the first pair of diametrically opposite corners (E,W) on odd numbered electrode plates and the second pair of diametrically opposite corners (N,S) on even numbered electrode plates. On FIG. 2, the pairs of diametrically opposite corners (E,W) and (S,N) are in a transverse position relative to each other.

The electrode plates and dielectric plates are preferably in an upright position, that is they are held in an essentially vertical position, preferably with two edges along a vertical axis Z and two edges along a horizontal axis X. This allows the non-conductive liquid being treated to descend freely, by gravitation alone, along the electrode plates.

The first and second electrical connectors are electrically connected at least to the edges, or the plate surfaces next to the edges, that is not more than 5 cm from the edges, in proximity to the corners of the electrode plates. The electrical connectors may for example be soldered, screwed, cinched, press-fit onto the edges.

According to an embodiment of the present invention, the first and second electrical connectors are electrically connected in proximity to the corners of their respective electrode plates, in proximity to the corners being at a distance from the respective corners of up to 15% of either length of whichever edge is the longest of the two edges meeting at this corner. According to certain advantageous embodiments, the first and second electrical connectors may be electrically connected at a distance from the respective corners of up to 10% of the length of whichever edge is the longest of the two edges meeting at this corner.

According to an embodiment of the present invention, the odd numbered electrode plates are connected via the first electrical connectors to a first terminal of the AC power source and the even numbered electrode plates are connected via the second electrical connectors to a second terminal of the AC power source.

According to an embodiment of the present invention, the device may be provided with two first electrical collectors, electrically connected to the first electrical connectors and two second electrical collectors electrically connected to the second electrical connectors.

According to an embodiment of the present invention one of the two first electrical connectors is electrically connected to the first electrical connectors electrically connected to the same corners of the odd numbered electrode plates and the other of the two first electrical connectors is electrically connected to the first electrical connectors electrically connected to the diametrically opposite corners of the odd numbered electrode plates. Likewise, according to an embodiment of the present invention, one of the two second electrical connectors is electrically connected to the second electrical connectors electrically connected to the same corners of the even numbered electrode plates and the other of the two second electrical connectors is electrically connected to the second electrical connectors electrically connected to the diametrically opposite corners of the even numbered electrode plates.

According to an embodiment of the present invention the device comprises a distributor for a non-conducting liquid. The distributor may be configured for distributing non-conducting liquid to be treated along the surfaces of the electrode plates and optionally of the dielectric plates. Several types of distributors are known in the art, they may for example be channel-type distributors or splash-plate type distributors. The liquid distributors to be used in the current device are preferably adapted to distribute liquids of a large range of viscosities. In certain embodiments, the distributor may be positioned above the electrode plates and optionally above de dielectric plates and configured for a downwards flow of the liquid.

According to an embodiment of the present invention the device is provided with a circulation circuit outside the enclosure. The presence of a first inlet and a first outlet for the non-conducting liquid in the enclosure allows the non-conducting liquid to circulate outside the enclosure.

According to an advantageous embodiment of the present invention the device is provided with a temperature control system comprising one or more of the following: a cooling device, a heating system, a temperature measurement system. Advantageously, the non-conducting liquid may circulate through a cooling device to avoid overheating of non-conducting liquid as the plasma treatment tends to increase the temperature of the non-conducting liquid. This cooling device may comprise a heat exchanger and/or a 3 way valve for injecting cooler non-conducting liquid in order to keep the treatment temperature in a desired range. The heating system may comprise a heating device placed around the enclosure to heat said enclosure containing said non-conducting liquid. The heating system may further allow the temperature of the enclosure to be controlled and to keep it constant, despite the temperature fluctuations that may occur in the environment of the enclosure. Furthermore, when a non-conducting liquid of fat- or wax-type is used, this heating system allows said liquid to be supplied at or above its melting temperature, in order for it to be in liquid form in the enclosure. Advantageously, said temperature measurement system comprises a temperature probe directly submerged in the non-conducting liquid in the enclosure, at the outlet of the enclosure, or in the circulation circuit. The temperature probe is preferably configured to continuously measure the temperature of the non-conducting liquid. Within the temperature control system, the temperature probe may be connected to a controller, itself connected to the heating and/or cooling system in order to control the heating and/or cooling so the temperature of the non-conducting liquid within the device is controlled and kept constant.

In a preferred embodiment of the present invention, the temperature control system is configured to maintain the non-conducting liquid at a temperature ranging between 50 and 100° C. and more preferably between 55 and 85° C.

In another advantageous embodiment the device of the present invention comprises a filter for filtering the processed non-conducting liquid. The filter may be placed at an outlet such as to filter the processed liquid at the and of the process. Alternately The non-conducting liquid may circulate through a filter, placed outside the enclosure. The passage through a filter allows the homogeneity of the processed material to be maintained following the intense and effective plasma applied to the non-conducting liquid. The filter may have meshes whose size ranges between 0.01 and 1 mm, preferably between 0.015 and 0.8 mm. Advantageously, the filter is a metal filter.

IN an embodiment of the present invention, the circulation of the non-conducting liquid outside the enclosure and its return via the an inlet of the enclosure may also allow said non-conducting liquid to be distributed over the electrode plates and optionally the dielectric plates.

In an embodiment of the present invention, the device further comprises a viscometer having a first inlet arranged to be in fluid connection with said first non-conducting liquid outlet of the enclosure and a first outlet, optionally arranged to be in fluid connection with the aforementioned filter, said viscometer being arranged to measure the viscosity of said non-conducting liquid, for example between said enclosure and said metal filter. The viscometer thus allows the viscosity of the non-conducting liquid to be measured throughout the processing. This viscosity measurement allows the control of the viscosity properties of the processed non-conducting liquid to be further improved. For example, a vibrating direct insertion viscometer, such as for example the Sofraser MIVI sensor, preferably with a temperature probe, may be used. The measurement may be made using a rod vibrating at resonance frequency where the vibration amplitude varies according to the viscosity of the liquid wherein it is immersed.

The invention advantageously further comprises a circulation pump having a first inlet in fluid connection with said first outlet of the enclosure and a first outlet, optionally in fluid connection with the aforementioned viscometer and/or the aforementioned filter, said circulation pump being arranged to circulate said non-conducing liquid between said first outlet and said first inlet of the enclosure.

According to an embodiment of the present invention the device further comprises a sampling valve in the circulation circuit. This will allow extract samples of treated material to monitor the quality and performance of the product during the treatment. In a particularly advantageous embodiment of the device according to the invention, said enclosure has a removal valve arranged to extract said liquid vegetable material out of the enclosure.

According to a preferred embodiment of the present invention n is greater than or equal to 4, advantageously greater than or equal to 5, more advantageously greater than or equal to 6, more advantageously greater than or equal to 7. The increase in the number of electrodes and the number of dielectric materials allows the effectiveness of the processing of the non-conductive liquid to be increased by increasing the contact surface between the electrical discharge and the non-conductive liquid present in the form of a film on the electrode plates and the dielectric plates. In certain embodiments of the present invention n may be equal to or less than 100, alternately equal to or less than 50, alternately equal to or less than 30.

According to an embodiment of the present invention, the device's electrode plates have a thickness comprised between 0.5 mm and 10 mm, preferably between 0.8 mm and 6 mm, more preferably between 1 mm and 3 mm.

According to an embodiment of the present invention the devices electrode plates and dielectric plates are essentially rectangular, having a surface area comprised between 0.2 m² and 4 m².

The construction material for the electrode plates are preferably sufficiently electrically conductive so that voltage variations can be quickly established, so that resistive heating of the electrode plates is limited and so that they can carry the necessary electrical current to sustain the discharge. According to an embodiment of the present invention electrode plates' materials comprise metals, metal alloys, metal compounds, carbon, carbon compounds, conductive ceramics, or semiconductors. Advantageously used materials may comprise metal alloys or graphitic carbon, in particular steel, stainless steel, copper, or aluminum.

According to an embodiment of the present invention each dielectric plate's material may be chosen from the group composed of a glass, quartz, a mica, a rigid polymer and mixtures thereof. The glass may for example soda lime glass, borosilicate glass, or alumino silicate glass. In an advantageous embodiment the dielectric plates' material may comprise a rigid polymer. In an advantageous embodiment the dielectric plates' material may have a dielectric constant at 10 to 60 Hz greater than or equal to 1.9. In an advantageous embodiment the dielectric plates' material may have an operating temperature, greater than or equal to 80° C., where it resists in continuous operation. Preferably the operating temperature is greater or equal to 150°, more preferably greater or equal to 200° C. In an advantageous embodiment the dielectric strength of the dielectric plate's material according to standard IEC60243 is equal to or greater than 10 kV/mm.

In an embodiment of the present invention, the dielectric plates are essentially rectangular, preferably having a thickness ranging between 0.5 mm and 10 mm, preferably between 2 mm and 6 mm.

In a preferred embodiment the surface area of the dielectric plates is between 3 and 25% and more preferably between 6 and 15% larger than the surface area of the electrode plates.

Another advantage of the device according to the present invention is that this also allows the characteristic odor of animal or vegetable oils to be reduced, or even eliminated. This reduction of the odor from fatty substances of animal or plant origin is, for example, advantageous for applications in the cosmetic or food fields where too-strong odors from fatty substances of plant origin used as a lubricating base are to be avoided.

The device according to the present invention therefore allows a fatty substance of animal or plant origin processed by electrical discharges to be produced on a large scale and reproduced with controllable, controlled and, advantageously, deodorized features.

Other embodiments of the device according to the invention are indicated in the appended claims.

The present invention also relates to a system for the electrical discharge processing of a non-conductive liquid comprising a plurality of devices, for example 2, 3, 4, or more devices, according to the invention, said devices being placed in series and/or in parallel to one another. The plurality of devices may be share one and the same enclosure.

Other embodiments of the system according to the invention are indicated in the appended claims.

The present invention also relates to a method for electrical discharge processing of a non-conducting liquid using a device for the electrical discharge processing of a non-conducting liquid according to any embodiment or any possible combination of embodiments described hereinabove.

The present invention in particular relates to a method for electrical discharge processing of a non-conducting liquid comprising:
a. providing in an enclosure at least one alternating succession of essentially rectangular, parallel, and spaced-apart n electrode plates and n+1 dielectric plates, with n≥2, the electrode plates being numbered from 1 to n;
b. providing an AC power source supplying an alternating bipolar voltage at a first terminal and an opposed alternating bipolar voltage at a second terminal;
c. optionally providing a hydrogen containing vacuum atmosphere in said enclosure;
d. introducing the non-conducting liquid into said enclosure via the first inlet of said enclosure,
e. distributing said non-conducting liquid on the surfaces of said n electrode plates and, optionally n+1 dielectric plates and forming a film of non-conducting liquid on the surface of said electrodes and optionally said dielectric plates,
   said method being characterized in that:
f. the alternating bipolar voltage is provided to all even numbered electrode plates in proximity to a pair of first diametrically opposite corners, the first terminal being electrically connected to first electrical connectors and g the first electrical connectors being electrically connected to all even numbered electrode plates in proximity to a pair of first diametrically opposite corners, and
g. the opposed alternating bipolar voltage is provided to all odd numbered electrode plates in proximity to a pair of second diametrically opposite corners, the second terminal being electrically connected to second electrical connectors; the second electrical connectors being electrically connected to all odd numbered electrode plates in proximity to a pair of second diametrically opposite corners.

The method according to the present invention allows the processing of a non-conducting liquid using a plasma that is established between the electrode plates.

The application of an alternating voltage at diametrically opposed corners of the electrode plates results in a uniform plasma over the whole surface of the electrode plates, while the formation of arcs or other forms of hot spots is minimized.

This results in obtaining a homogeneously treated non-conducting liquid.

The treated non-conducting liquid obtained following the processing in the device according to the present invention may be characterized by a relaxation time of less than or equal to 200 s measured at 40° C. by a cone-plate viscometer, according to the ISO 2884-1 standard. The relaxation time corresponds to the time necessary for the lubricating substance, which has viscoelastic properties, to return to its initial state when it is subjected to shearing stress. A stress is applied to a sample of treated non-conducting liquid and the resulting response to this stress may be monitored over time while carrying out the process.

The device according to the present invention thus allows a non-conducting liquid to be processed, or treated, and a processed or treated non-conducting liquid having appropriate viscoelastic properties to be obtained. For example, the processed non-conducting liquid in the device according to the invention, even when it is subjected to a stress, particularly in engines, quickly returns to its initial viscosity after the application of this stress. This feature of relaxation time of less than or equal to 200 s allows the non-conducting liquid to maintain a relatively stable and constant viscosity over time despite the application of stresses.

Advantageously, the method according to the invention is characterized in that the power source's high voltage applied to the electrode plates ranges between 1 kV and 10 kV, preferably between 2 kV and 3 kV, the frequency advantageously ranges between 3 kHz and 100 kHz, more advantageously between 5 kHz and 70 kHz, more advantageously between 10 kHz and 40 kHz.

In a particular embodiment of the method according to the invention, the said non-conducting liquid is circulated between the first non-conducting liquid outlet of the enclosure and said non-conducting liquid inlet of the enclosure. Optionally, the non-conducting liquid may be filtered while being circulated. Optionally the non-conductive liquid may be heated or cooled while being circulated, either to prevent overheating or to maintain appropriate flow characteristics, i.e. viscosity.

In an embodiment of the present invention distributing said non-conducting liquid is obtained by formation of a film of non-conducting liquid on the surface of said electrodes and optionally on said dielectric materials is obtained by a spray, or by channel-type distributors or splash-plate type distributors.

The present invention further relates to any embodiment or combination of embodiments hereinabove and indicated in the appended claims.

1. A device for electrical discharge processing of a non-conducting liquid, the device comprising:
at least one alternating succession of essentially rectangular, parallel, and spaced-apart n electrode plates and n+1 dielectric plates, with n≥2, the electrode plates being numbered from 1 to n;
a series of first electrical connectors electrically connected to all even numbered electrode plates in proximity to a first pair of diametrically opposite corners;
a series of second electrical connectors electrically connected to all odd numbered electrode plates in proximity to a second pair of diametrically opposite corners, and
an AC power source having a first pole connected to the series of first electrical connectors and a second pole connected to the series of second electrical connectors.

2. The device for the electrical discharge processing of the non-conducting liquid according to claim 1, wherein the electrode plates and the dielectric plates are held apart by one or more guide rails positioned at the bottom, at top and/or at sides of the electrode plates and the dielectric plates.

3. The device for the electrical discharge processing of the non-conducting liquid according to claim 1, wherein a surface area of the dielectric plates is larger than a surface area of the electrode plates.

4. The device for the electrical discharge processing of the non-conducting liquid according to claim 1, further comprising an enclosure wherein the at least one alternating successions of the electrode plates and the dielectric plates are placed.

5. The device for the electrical discharge processing of the non-conducting liquid according to claim 4, wherein the enclosure further comprises a first non-conducting liquid outlet, situated in a lower part of the enclosure and a non-conducting liquid inlet, situated in an upper part of the enclosure.

6. The device for the electrical discharge processing of the non-conducting liquid according to claim 4, wherein the enclosure comprises at least two separate electrical feedthrough connectors via which the odd numbered electrode plates and the even numbered electrode plates are respectively electrically connected to the AC power source.

7. The device for the electrical discharge processing of the non-conducting liquid according to claim 4, wherein the enclosure further comprises at least one gas inlet port for admitting one or more process gasses.

8. The device for the electrical discharge processing of the non-conducting liquid according to claim 1, wherein first pairs of diametrically opposite corners and second pairs of diametrically opposite corners are positioned transversely to each other.

9. The device for the electrical discharge processing of the non-conducting liquid according to claim 1, wherein the series of first electrical connectors and the series of second electrical connectors are electrically connected at a distance from the respective corners of up to 15% of either length of whichever edge is a longest of two edges meeting at said respective corners.

10. The device for the electrical discharge processing of the non-conducting liquid according to claim 1, further comprising a liquid distributor.

11. The device for the electrical discharge processing of the non-conducting liquid according to claim 1, wherein the electrode plates have a surface area between 0.2 and 4 m².

12. The device for the electrical discharge processing of the non-conducting liquid according to claim 1, wherein the electrode plates comprise metals, metal alloys, metal compounds, carbon, carbon compounds, conductive ceramics, or semiconductors.

13. The device for the electrical discharge processing of the non-conducting liquid according to claim 1, wherein a surface area of the dielectric plates is between 10 and 25% larger than a surface area of the electrode plates.

14. The device for the electrical discharge processing of the non-conducting liquid according to claim 1, wherein the dielectric plates comprise glass, quartz, mica, rigid polymer and mixtures thereof.

15. The device for the electrical discharge processing of the non-conducting liquid according to claim 1, further comprising a distributor for said non-conducting liquid.

16. A method for electrical discharge processing of a non-conducting liquid comprising:
a. providing in an enclosure at least one alternating succession of essentially rectangular, parallel, and spaced-apart n electrode plates and n+1 dielectric plates, with n≥2, the electrode plates being numbered from 1 to n;
b. providing an AC power source supplying an alternating bipolar voltage at a first terminal and an opposed alternating bipolar voltage at a second terminal;
c. optionally providing a hydrogen containing vacuum atmosphere in said enclosure;
d. introducing the non-conducting liquid into said enclosure via a first inlet of said enclosure,
e. distributing said non-conducting liquid on a surfaces of said n electrode plates and, optionally n+1 dielectric plates, and forming a film of non-conducting liquid on a surface of said electrodes and optionally said dielectric plates,
wherein:
f. the alternating bipolar voltage is provided to all even numbered electrode plates in proximity to a pair of first diametrically opposite corners, the first terminal being electrically connected to a series of first electrical connectors and the series of first electrical connectors being electrically connected to all even numbered electrode plates in proximity to a pair of first diametrically opposite corners, and
g. the opposed alternating bipolar voltage is provided to all odd numbered electrode plates in proximity to a pair of second diametrically opposite corners, the second terminal being electrically connected to a series of second electrical connectors; the series of second electrical connectors being electrically connected to all odd numbered electrode plates in proximity to a pair of second diametrically opposite corners.
